(19) United States
(12) Patent Application Publication
(10) Pub. No.: US 2005/0283531 A1
(43) Pub. Date: Dec. 22, 2005

(54) Method and apparatus for combining resource properties and device operations using stateful Web services

(75) Inventors: Paul Ming Chen, (US); Rick Hsi Cheng Chen, (US); Andrew Niel Trossman, (US)

Correspondence Address: IBM CORP (YA);C/O YEE & ASSOCIATES PC, P.O. BOX 802333, DALLAS, TX, 75380, US

(73) Assignee: International Business Machines Corporation, Armork, NY (US)

(21) Appl. No.: 10/870,346

(22) Filed: Jun. 17, 2004

(51) Int. Cl. G06F 15/173; G06F 15/16

(52) U.S. Cl. 709/225; 709/229

(57) ABSTRACT

A stateful Web services interface that combines resource properties and logical device operations is provided. The interface allows an administrator to access an instance of a given resource in a data center. The instance is persistent throughout the Web services session. Through the persisted instance, an administrator may invoke device operations to manipulate the given resource. The administrator may also access and modify associated resource properties using the persisted instance.

### CROSS REFERENCE TO RELATED APPLICATION

The present invention is related to the following application entitled “METHOD AND APPARATUS FOR MANAGING DATA CENTER USING WEB SERVICES”, Ser. No. ______ attorney docket no. CA920040063US1, filed even date hereof. The above related application is assigned to the same assignee, and is incorporated herein by reference.

### BACKGROUND OF THE INVENTION

1. Technical Field

The present invention relates generally to an improved data processing system. In particular, the present invention relates to a method and apparatus for combining resource properties and device operations. Still more particularly, the present invention relates to a method and apparatus for combining resource properties and device operations using stateful Web services.

2. Description of Related Art

Currently, data center, which includes many different types of servers and hardware, are managed by administrators using management tools, such as, for example, Tivoli Intelligent Orchestrator, a product available from International Business Machines Corporation. Such management tools help administrators to manage resources in a data center by allowing administrators to access and modify resource properties of a given resource. An example resource property is a TCP port number of a given server. These management tools also allow administrators to manually execute device operations to manipulate the resource, such as, calling scripts to add a server to a cluster.

While these management tools provide administrators opportunities to access or modify resources properties and perform device operations on data center resources, these tasks remain separate and require separate interface implementations. Thus, using these management tools, administrators have to invoke two different sets of interface: one interface for accessing and modifying attributes of resources and another interface for manipulating physical resources by changing or moving resources around in a data center.

These management tools fail to correlate resource properties with the device operations that can be performed on a given resource. Therefore, a need exists for a method that provides a single interface, which combines resource properties manipulation with resource operations, such that administrators may manage data center resources more efficiently.

In addition, a data center is operating in an asynchronous manner. A device operation may take a long time to complete. However, there is no existing solution that recognizes the need to access resource properties while operations are processed. Therefore, a need also exists for a single interface that allows administrators to retrieve resource properties while waiting for operation completion, such that administrators may make resource allocation decisions accordingly.

### SUMMARY OF THE INVENTION

The present invention provides a method, apparatus, and computer instructions for combining resource properties and device operations by applying stateful Web services. The present invention provides a stateful Web services interface, which allows a client to access an instance of a given resource in a data center. The interface includes a Web Services Definition Language file that defines a set of resource properties and a set of device operations. The client may manipulate resource properties and invoke device operations on the given resource using the persistent instance.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a network of data processing systems in which the present invention may be implemented;

FIG. 2 is a block diagram of a data processing system that may be implemented as a server in accordance with a preferred embodiment of the present invention;

FIG. 3 is a block diagram of a data processing system in which the present invention may be implemented;

FIG. 4 is a diagram illustrating an exemplary data center in accordance with a preferred embodiment of the present invention;

FIG. 5 a diagram illustrating an exemplary invocation of stateful Web service to manage a data center resource in accordance with a preferred embodiment of the present invention;

FIG. 6A is a diagram illustrating an exemplary WSDL file provided by the present invention in accordance with a preferred embodiment of the present invention;

FIG. 6B is a diagram illustrating a continuation of exemplary WSDL file 600 in FIG. 6A in accordance with a preferred embodiment of the present invention;

FIG. 6C is a diagram illustrating a continuation of exemplary WSDL file 600 in FIG. 6B in accordance with a preferred embodiment of the present invention;

FIG. 6D is a diagram illustrating a continuation of exemplary WSDL file 600 in FIG. 6C in accordance with a preferred embodiment of the present invention;

FIG. 6E is a diagram illustrating a continuation of exemplary WSDL file 600 in FIG. 6D in accordance with a preferred embodiment of the present invention;

FIG. 6F is a diagram illustrating a continuation of exemplary WSDL file 600 in FIG. 6E in accordance with a preferred embodiment of the present invention;

FIG. 7 is a diagram illustrating an exemplary client implementation using stateful Web services to invoke device operations and manipulate resource properties in accordance with a preferred embodiment of the present invention; and

FIG. 8 is a diagram illustrating relationships between resources in a data center in accordance with a preferred embodiment of the present invention.

### DETAILED DESCRIPTION OF THE PREFERRED EMBODIMENT

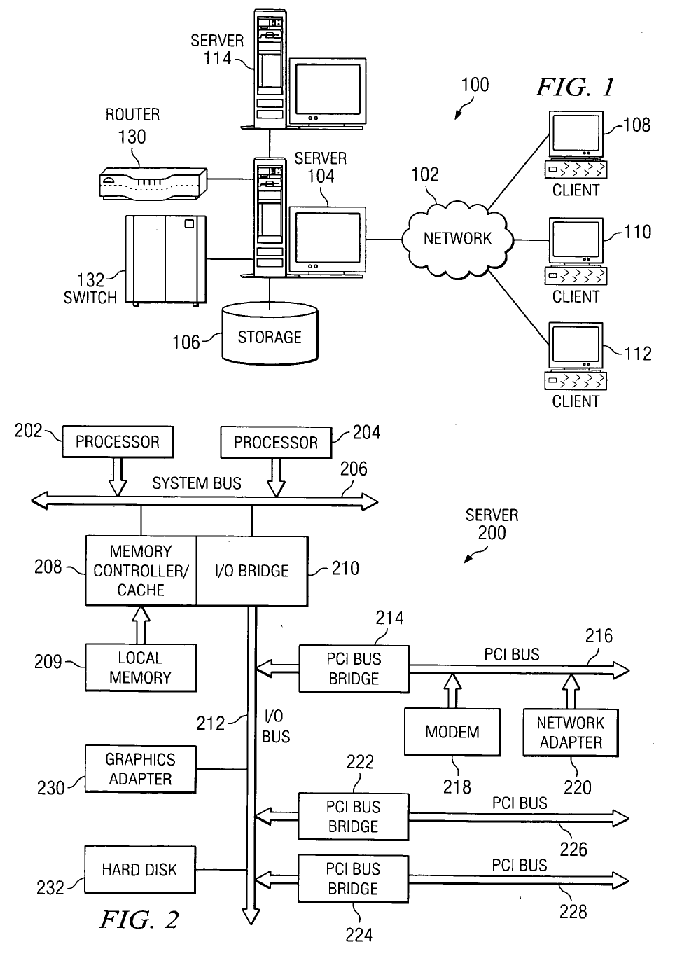

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, server 104 is connected to network 102 along with storage unit 106. In addition, clients 108, 110, and 112 are connected to network 102. These clients 108, 110, and 112 may be, for example, personal computers or network computers. In the depicted example, server 104 provides data, such as boot files, operating system images, and applications to clients 108-112. Clients 108, 110, and 112 are clients to server 104. Network data processing system 100 may include additional servers, clients, and other devices not shown.

Furthermore, server 104 may be connected to other resources, such as router 130, server 114, switch 132 and storage 106. In the present invention, these resources in combination with network data processing system 100 make up a data center.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to clients 108-112 in FIG. 1 may be provided through modem 218 and network adapter 220 connected to PCI local bus 216 through add-in connectors.

Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM eServer™ pSeries® system, a product of International Business Machines Corporation in Armonk, N.Y., running the Advanced Interactive Executive (AIX™) operating system or LINUX operating system.

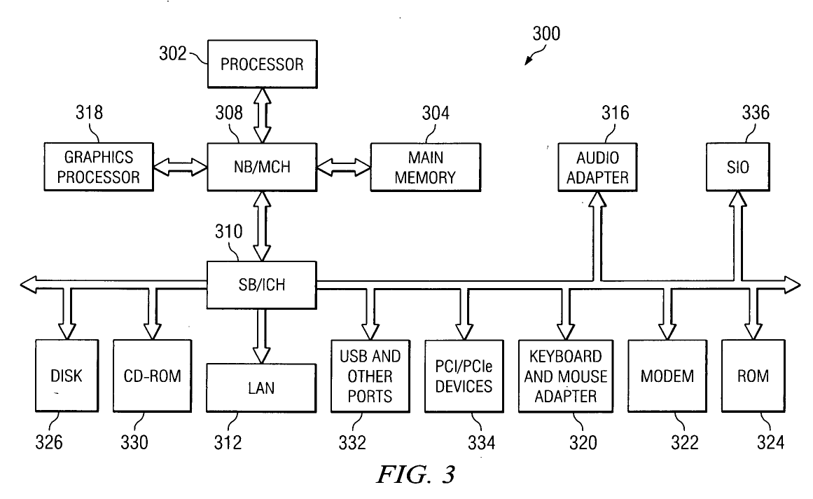

With reference now to FIG. 3, a block diagram of a data processing system is shown in which the present invention may be implemented. Data processing system 300 is an example of a computer, such as client 108 in FIG. 1, in which code or instructions implementing the processes of the present invention may be located. In the depicted example, data processing system 300 employs a hub architecture including a north bridge and memory controller hub (MCH) 308 and a south bridge and input/output (I/O) controller hub (ICH) 310. Processor 302, main memory 304, and graphics processor 318 are connected to MCH 308. Graphics processor 318 may be connected to the MCH through an accelerated graphics port (AGP), for example.

In the depicted example, local area network (LAN) adapter 312, audio adapter 316, keyboard and mouse adapter 320, modem 322, read only memory (ROM) 324, hard disk drive (HDD) 326, CD-ROM driver 330, universal serial bus (USB) ports and other communications ports 332, and PCI/PCIe devices 334 may be connected to ICH 310. PCI/PCIe devices may include, for example, Ethernet adapters, add-in cards, PC cards for notebook computers, etc. PCI uses a cardbus controller, while PCIe does not. ROM 324 may be, for example, a flash binary input/output system (BIOS). Hard disk drive 326 and CD-ROM drive 330 may use, for example, an integrated drive electronics (IDE) or serial advanced technology attachment (SATA) interface. A super I/O (SIO) device 336 may be connected to ICH 310.

An operating system runs on processor 302 and is used to coordinate and provide control of various components within data processing system 300 in FIG. 3. The operating system may be a commercially available operating system such as Windows XP™, which is available from Microsoft Corporation. An object oriented programming system, such as the Java™ programming system, may run in conjunction with the operating system and provides calls to the operating system from Java™ programs or applications executing on data processing system 300. “JAVA” is a trademark of Sun Microsystems, Inc.

Instructions for the operating system, the object-oriented programming system, and applications or programs are located on storage devices, such as hard disk drive 326, and may be loaded into main memory 304 for execution by processor 302. The processes of the present invention are performed by processor 302 using computer implemented instructions, which may be located in a memory such as, for example, main memory 304, memory 324, or in one or more peripheral devices 326 and 330.

Those of ordinary skill in the art will appreciate that the hardware in FIG. 3 may vary depending on the implementation. Other internal hardware or peripheral devices, such as flash memory, equivalent non-volatile memory, or optical disk drives and the like, may be used in addition to or in place of the hardware depicted in FIG. 3. Also, the processes of the present invention may be applied to a multiprocessor data processing system.

For example, data processing system 300 may be a personal digital assistant (PDA), which is configured with flash memory to provide non-volatile memory for storing operating system files and/or user-generated data. The depicted example in FIG. 3 and above-described examples are not meant to imply architectural limitations. For example, data processing system 300 also may be a tablet computer, laptop computer, or telephone device in addition to taking the form of a PDA.

The present invention provides a method, apparatus, and computer instructions for combining resource properties and device operations using stateful Web services. A resource is a device in a data center, for example, a server. The present invention provides a stateful Web services interface on a client, which may be an administrator. When the client invokes the interface for a data center resource, the server associates an instance of the desired resource with a Web service and returns the instance to the client.

The invocation is made on the client by first specifying a resource property, such as a server name. Other resource property may also be used to invoke the resource. The resource property identifies a resource in the data center. However, since resource properties may not be unique, a client has to decide which resource property to use if more than one instance is returned. The client then sends a query to search for an endpoint reference that uniquely identifies the resource at the instance level. Once an endpoint reference is located, the server associates the endpoint reference with a Web service and returns the endpoint reference to the client.

Once the endpoint reference is received by the client, the endpoint reference is added to a SOAP header, so that the resource is now persistent on the client within the scope of the Web services session. No resource id is need for subsequent requests. Using the instance of the resource, the client may retrieve and modify the resource properties. Resource properties define a set of attributes that an instance of the data center resource owns. Examples of resource properties include name of the resource, domain specific resource identifier, the type of resource, and descriptions of the resource. Examples of server specific resource properties include TCP port number, pool name, cluster id, and cluster name.

Using the persisted instance, the client may also invoke logical device operations or other device operations on the resource. Logical device operations define a set of tasks that can be used to manipulate the physical resource in the data center. Examples of device operations include adding a server to a cluster, removing a server from a cluster, and setting a server in maintenance mode. In addition to operations for a particular resource, device operations also define a set of tasks that associates and disassociates relationships between different resources. For example, an application resource may be owned by a customer resource.

Logical device operations (LDOs) provides a high level view of the resource operations that a user may run, for example, a LDO named Cluster.AddServer provides a base interface for a user to add a server to a cluster. Workflows are implementation of the LDO, which include low level scripts for manipulating a resource. When a user may invoke a LDO with a device id, the present invention determines which workflow implementation should be invoked for the given LDO. A user may also define association between workflows and a LDO.

The resource properties and device operations are defined in a Web Services Definition Language (WSDL) file. In the present invention, the WSDL definitions are shared by both the client and the server, such that the client may invoke operations and access/modify resource attributes defined in the file when the resource instance is obtained.

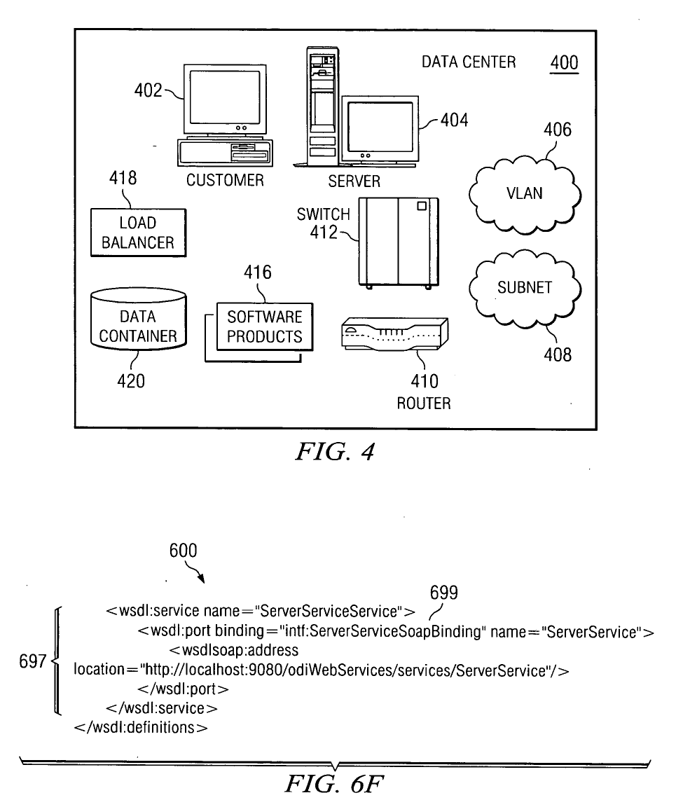

Turning now to FIG. 4, a diagram illustrating an exemplary data center is depicted in accordance with a preferred embodiment of the present invention. As shown in FIG. 4, in this illustrative example, data center 400 includes resources, such as, customer 402, server 404, Virtual Local Area Network (VLAN) 406, subnet 408, router 410, switch 412, software products 416, load balancer 418, and data container 420.

Customer 402 may be, for example, a client or an administrator who uses a data processing system, such as data processing system 300 in FIG. 3. Server 404 may be implemented as a data processing system, such as data processing system 200 in FIG. 2. Server 404 may also be implemented as an application server, which hosts Web services, or other types of servers. Router 410 and switch 412 facilitate communications between different devices. VLAN 406 is a network of computers that behave as if they are connected to the same wire even though they may actually be physically located on different segments of a local area network. Subnet 408 is a portion of a network, which may be a physically independent network segment and shares a network address with other portions of the network.

Software products 416 are applications that may be executed on a client or a server. Load balancer 418 spreads task among multiple systems such that no single system is overwhelmed. Load balancer 418 is normally implemented as software running on a data processing system. Data container 420 may be a database, such as DB2 Universal Database, a product available from International Business Machines Corporation.

Data center 400, as depicted in FIG. 4, is presented for purposes of illustrating the present invention. Other resources, such as, for example, cluster of servers and switch port, also may be included in data center 400.

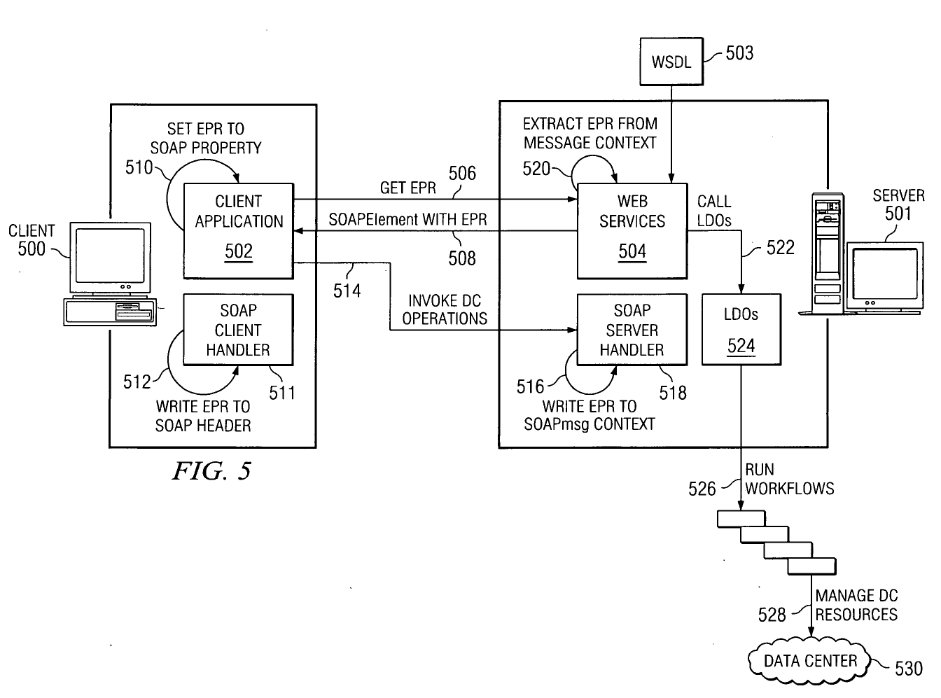

Turning now to FIG. 5, a diagram illustrating an exemplary invocation of a stateful Web service to manage a data center resource is depicted in accordance with a preferred embodiment of the present invention. As depicted in FIG. 5, in this illustrative example, when client 500 wants to invoke a data center operation on a resource, client 500 first invokes client application 502 to access an instance of this resource from server 501. Client application 502 accesses the instance by retrieving an endpoint reference of the resource from WSDL file 503 (call 506). The endpoint reference is retrieved by using a resource property, such as a server name. Once the instance of the resource, Web services 504, is accessed, the endpoint reference is returned to client application 502 in a SOAP element (call 508).

When the endpoint reference is received by client application 502, client application 502 sets the endpoint reference in a property of the SOAP stub (call 510). In addition, SOAP client handler 511 sets the endpoint reference to the SOAP message header, such that subsequent requests through the stub may re-use the same endpoint reference (call 512). Once the endpoint reference is set in the SOAP header, the resource is now persistent within the scope of the current Web services session and client 500 may access the instance of the resource to invoke a data center operation or retrieve properties for the resource (call 514).

After a data center operation is invoked by client 500 via client application 502, SOAP server handler 518 writes the endpoint reference to a SOAP message context (call 516) for Web services 504 to extract (call 520). When the endpoint reference is extracted, a resource id is retrieved from the message context which identifies a particular resource in the data center to invoke the operation on. After the resource id is retrieved, Web services 504 calls logical device operations 524, which is a high-level encapsulation of lower level workflow scripts to perform a specific data center operation (call 522). The logical device operations 524 run lower level workflows scripts (call 526) to manage resource of data center 530 accordingly (call 528). Web services 504 may also call other device operations to perform a specific data center resource operation.

Thus, using the stateful Web services, an administrator is able to access the instance of a given resource, such that the administrator may create or destroy the instance at any time. In addition, the administrator also may retrieve or set attributes for the given resource, interrogate relationships associated with the given resource and invoke data center operations on the given resource. Furthermore, there is no need for the client to submit a resource ID each time, as in the case of stateless Web services, as an input parameter to the Web service, because the state of the resource is now persistent.

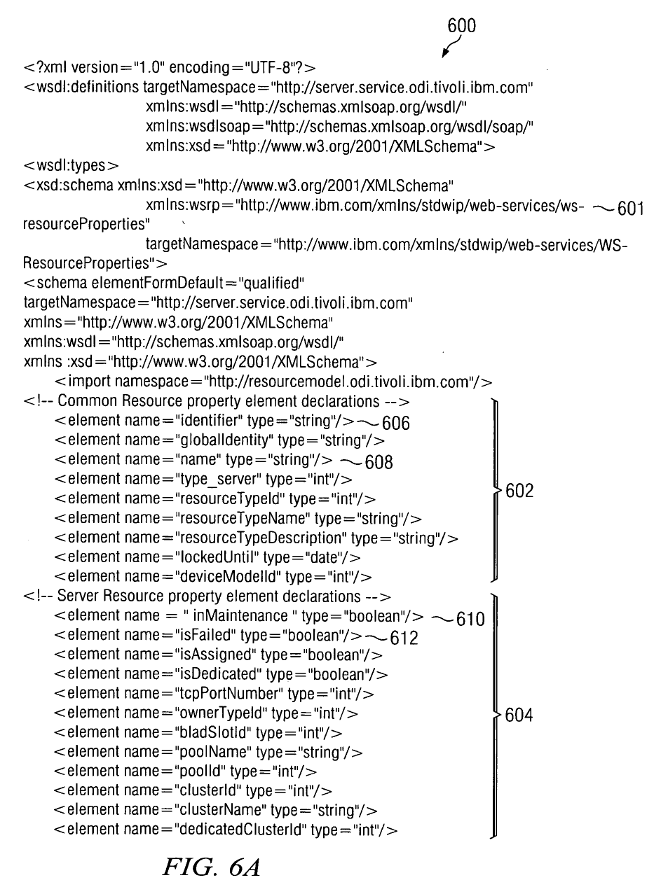

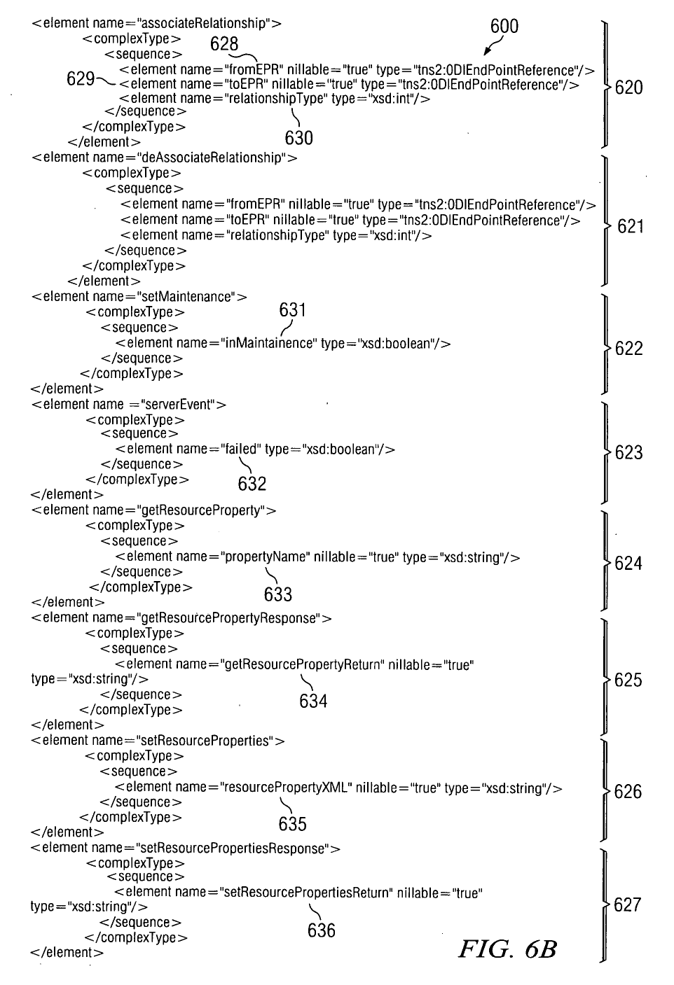

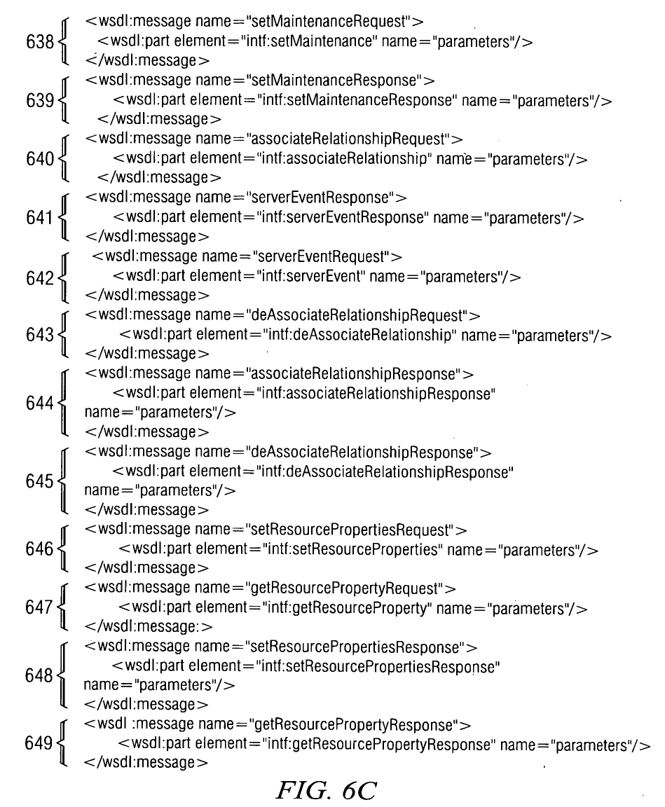

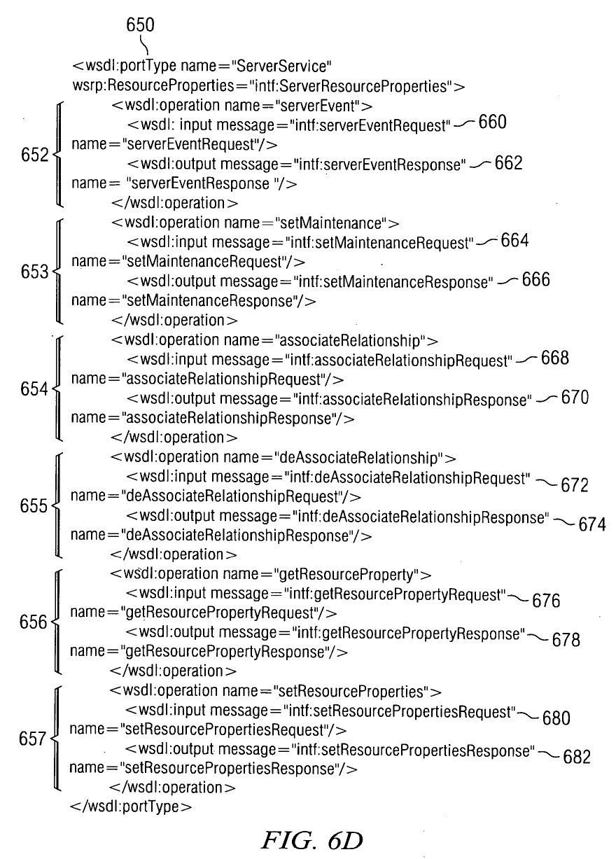

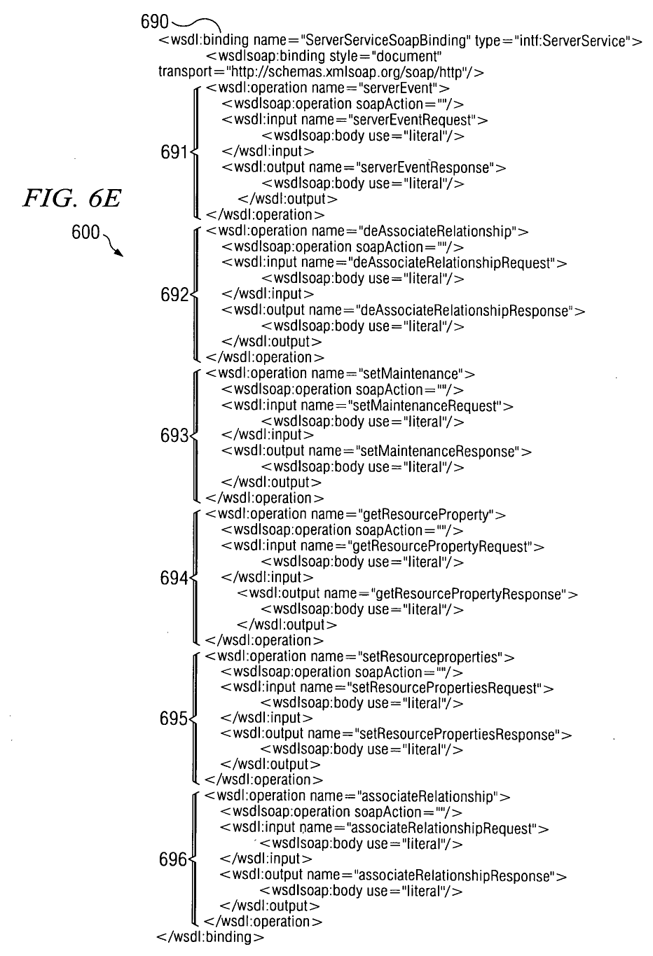

Turning now to FIG. 6A, a diagram illustrating an exemplary WSDL file provided by the present invention is depicted in accordance with a preferred embodiment of the present invention. As depicted in FIG. 6A, WSDL file 600 adheres to the standard of Web Services Definition Language (WSDL). In the schema section 601, a number of common 602 and server resource properties 604 are defined. Common resource properties 602 are shared by all data center resources and server resource properties 604 are specific to a server resource. Examples of common properties 602 include an identifier 606 and a name of the resource 608. Examples of server resource properties 604 include in Maintenance 610 and is Failed 612.

Turning now to FIG. 6B, a diagram illustrating a continuation of exemplary WSDL file 600 in FIG. 6A is depicted in accordance with a preferred embodiment of the present invention. As depicted in FIG. 6B, in addition to resource properties 602 and 604 in FIG. 6A, the schema section of WSDL file 600 also defines a number of data elements that will be used by WSDL messages. In this illustrative example, there are eight data elements: elements 620-627.

Element 620, associate relationship, and element 621, deAssociateRelationship, each includes elements fromEPR 628, toEPR 630, and relationshipType 632. FromEPR 628 and toEPR 630 is represented by ODI endpoint reference type and relationshipType 632 is represented by an integer. Element 622, setMaintenance, includes an in Maintenance element 631, which is represented by a boolean. Thus, in Maintenance 631 may either be true or false. Element 623, serverEvent, includes a failed element 632, which is also represented by a boolean.

Element 624, getResourceProperty, includes a propertyName 633, which is represented by a string. Element 625, getResourcePropertyResponse, includes a getResourcePropertyReturn 634, which is represented by a string. Element 626, setResourceProperties, includes a resourcePropertyXML 635, which is represented by a string. Elements 627, setResourcePropertiesResponse, includes setResourcePropertyReturn 636, which is represented by a string.

Turning now to FIG. 6C, a diagram illustrating a continuation of exemplary WSDL file 600 in FIG. 6B is depicted in accordance with a preferred embodiment of the present invention. As depicted in FIG. 6C, subsequent to elements 620-627 in FIG. 6B, a number of WSDL message definitions are provided to define data elements of data center operations. Each message includes one or more parts. A message can be compared to an input or output of a function, which contains one or more parts, which are input or output parameters. In this illustrative example, there are twelve messages: messages 638-649. Message 638 represents a setMaintenanceRequest, which includes setMaintenance element 624 as part of the message. Message 639 represents setMaintenanceResponse, which includes setMaintenanceResponse element as part of the message. Message 640 represents an associateRelationshipRequest, which includes associateRelationship element 620 as part of the message.

Message 641 represents a serverEventResponse, which include serverEventResponse element as part of the message. Message 642 represents a serverEventRequest, which includes serverEvent element 623 as part of the message. Message 643 represents a deAssociateRelationshipRequest, which includes deAssociateRelationship element 621 as part of the message. Message 644 represents an associateRelationshipResponse, which includes associateRelationshipResponse element as part of the message. Message 645 represents a deassociateRelationshipResponse, which includes deassociateRelationshipResponse element as part of the message.

Message 646 represents a setResourcePropertiesRequest, which includes setResourceProperties element 626 as part of the message. Message 647 represents a getResourcePropertyRequest, which includes getResourceProperty element 624 as part of the message. Message 648 represents a setResourcePropertiesResponse, which includes setResourcePropertiesResponse element 627 as part of the message. Message 649 represents a getResourcePropertiesResponse, which includes getResourcePropertiesResponse element 625 as part of the message.

Turning now to FIG. 6D, a diagram illustrating a continuation of exemplary WSDL file 600 in FIG. 6C is depicted in accordance with a preferred embodiment of the present invention. As depicted in FIG. 6D, after messages 638-649 are defined, portType 650 is defined in WSDL file 600. A portType in WSDL is similar to a function library in traditional programming, which includes a number of functions, herein refer to as operations.

In this illustrative example, operations 652-657 are defined using messages 638-649. Operation 652 represents a serverEvent operation that requires a serverEventRequest 660 as input parameter and serverEventResponse 662 as output parameter. ServerEventRequest 660 is represented by serverEventRequest message 642 in FIG. 6C and serverEventResponse 662 is represented by serverEventResponse message 641 in FIG. 6C.

Operation 653 represents a setMaintenance operation that requires a setMaintenanceRequest 664 message as input parameter and setMaintenanceResponse 666 as output parameter. SetMaintenanceRequest 664 is represented by SetMaintenanceRequest message 638 in FIG. 6C and setMaintenanceResponse 666 is represented by serverEventResponse message 639 in FIG. 6C.

Operation 654 represents an associateRelationship operation that requires a associateRelationshipRequest 668 as input parameter and associateRelationshipResponse 670 as output parameter. AssociateRelationshipRequest 668 is represented by associateRelationshipRequest message 640 in FIG. 6C and associateRelationshipResponse 670 is represented by associateRelationshipResponse message 644 in FIG. 6C.

Operation 655 represents a deAssociateRelationship operation that requires a deAssociateRelationshipRequest 672 as input parameter and deAssociateRelationshipResponse 674 as output parameter. DeAssociateRelationshipRequest 672 is represented by deAssociateRelationshipRequest message 643 in FIG. 6C and deAssociateRelationshipResponse 674 is represented by deAssociateRelationshipResponse message 645 in FIG. 6C.

Operation 656 represents a getResourceProperty operation that requires a getResourcePropertyRequest 676 as input parameter and getResourcePropertyResponse 678 as output parameter. GetResourcePropertyRequest 676 is represented by getResourcePropertyRequest message 647 in FIG. 6C and getResourcePropertyResponse 678 is represented by getResourcePropertyResponse message 649 in FIG. 6C.

Operation 657 represents a setResourceProperties operation that requires a setResourcePropertiesRequest 680 as input parameter and setResourcePropertiesResponse 682 as output parameter. SetResourcePropertiesRequest 680 is represented by setResourcePropertiesRequest message 646 in FIG. 6C and setResourcePropertyResponse 682 is represented by setResourcePropertiesResponse message 648 in FIG. 6C.

Turning now to FIG. 6E, a diagram illustrating a continuation of exemplary WSDL file 600 in FIG. 6D is depicted in accordance with a preferred embodiment of the present invention. As depicted in FIG. 6E, once operations 652-657 are defined, WSDL file 600 defines a binding 690 for the SOAP message format. Operations 691-696 represent operations 652-657 in FIG. 6D.

Turning now to FIG. 6F, a diagram illustrating a continuation of exemplary WSDL file 600 in FIG. 6E is depicted in accordance with a preferred embodiment of the present invention. As depicted in FIG. 6F, once soap message format is defined to include operations 691-696, WSDL file 600 includes definition of Web service 697 that includes all defined operations. In this example, ‘server service service’ 697 is defined to include the operations 691-696 of ServerServiceSoapBinding 699, which represents binding 690 in FIG. 6E. Thus, using WSDL file 600 in FIGS. 6A-6F, a client may invoke device operations, such as setMaintenance, or access/modify resource properties, such as customerid, on the resource by using stateful Web services, such as Server service service 697.

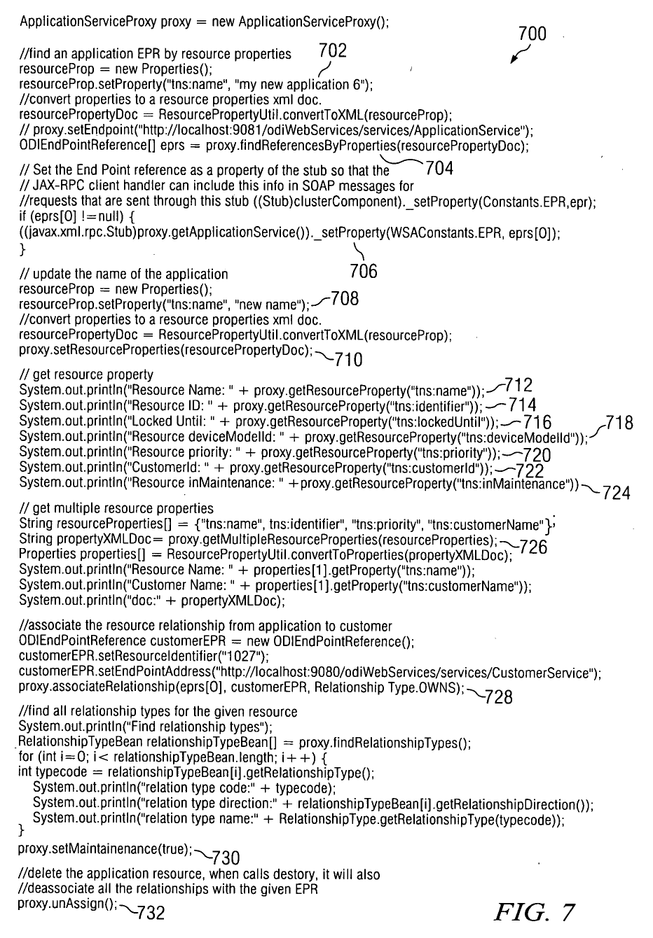

Turning now to FIG. 7, a diagram illustrating an exemplary client implementation using stateful Web services to invoke device operations and manipulate resource properties is depicted in accordance with a preferred embodiment of the present invention. As depicted in FIG. 7, in this illustrative example, client program 700 first sets a resource property to the desired application name. In this example, the desired application name is ‘my new application 6’ 702.

The client then sends a query to search for a resource instance based on the application name 702. The client uses findReferencesByProperties operation 704 to search for the resource instance. Once the resource instance is obtained, the endpoint reference is set as a property of the SOAP stub, such that the client handler may include the endpoint reference in subsequent SOAP messages. The endpoint reference is set by calling a setproperty method 706. The resource is now persistent on the client.

The client may then set any resource property on the resource as defined in the WSDL file, such as WSDL file 600 in FIGS. 6A-6F, using the resource instance. In this example, the client updates the name of the application to ‘new name’ 708 by using setResourceProperties operation 710. In addition, the client may retrieve resource properties from the resource, for example, name 712, identifier 714, lockedUntil 716, deviceModelId 718, priority 720, customerid 722, and in Maintenance 724. Furthermore, the client may retrieve multiple resource properties using getMultipleResourceProperties method 726.

The present invention provides operations that allow a user to define relationships between resources. In this illustrative example, the client associates the application resource with a customer resource with a relationship of ‘OWNS’ by using associationRelationship operation 728. Thus, the application resource is now owned by the customer. Other operations may also be performed on the application resource. For example, the client may set the application to be in maintenance by using setMaintenance operation 730. Thus, the application can be deleted once it is in maintenance by using unassign operation 732.

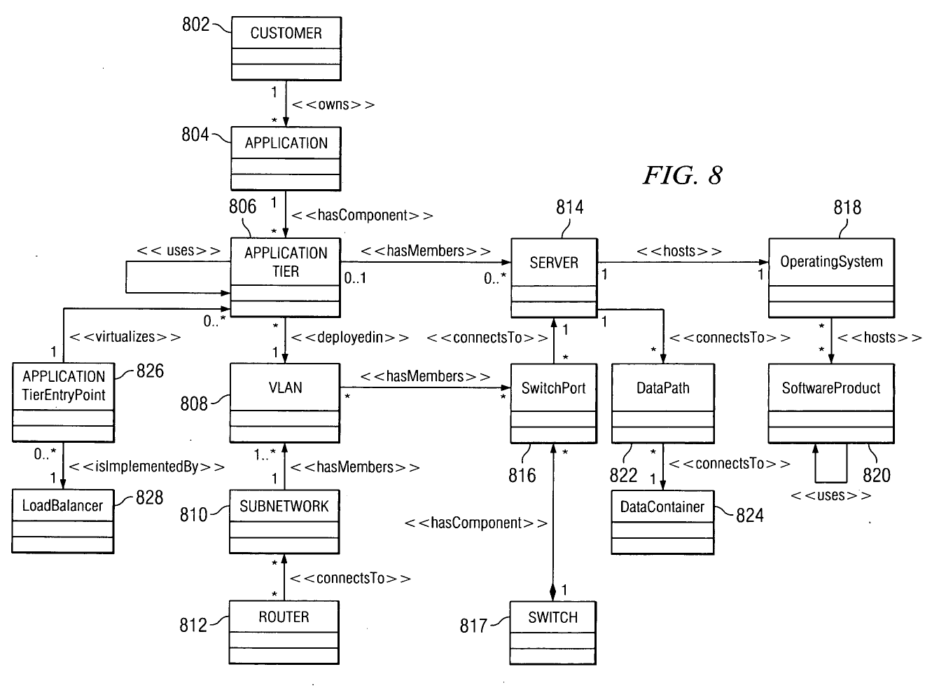

Turning now to FIG. 8, a diagram illustrating relationships between resources in a data center is depicted in accordance with a preferred embodiment of the present invention. As depicted in FIG. 8, in this illustrative example, customer 802 may own many applications 804. Each application 804 may have components of many application tiers 806 or clusters. Application tier 806 may be deployed in VLAN 808, which belongs to a subnetwork 810 that is connected to router 812. VLAN 808 may also have many switch port 816, which connects to server 814 and belongs to a switch 817.

Application tier 806 also has zero or more servers 814 as members. Server 814 hosts operation system 818, which hosts software products 820. Server 814 may also be connected to many data paths 822 which are connected to a data container 824 or database. Each application tier 806 is visualized by an application tier entry point 826, which is implemented by a load balancer 828.

In summary, the present invention provides a stateful Web services interface that combines device operations and resource properties. With the stateful Web service interface, an administrator may persist a resource instance and manipulate a data center resource throughout the Web service session. In addition to device operations for a particular resource, relationship may also be defined between different resources. Thus, using the mechanisms of the present invention, an administrator may manage the data center more efficiently and manipulate resource properties while the operations are processed to make management decisions.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media such a floppy disc, a hard disk drive, a RAM, and CD-ROMs and transmission-type media such as digital and analog communications links.

The description of the present invention has been presented for purposes of illustration and description, but is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

1. A method in a data processing system for combining resource properties and device operations of resources in a data center, the method comprising:
defining operations and attributes of resources in a Web services definition language file;
invoking an interface for an instance of a resource in the data center; and
invoking an operation on the instance, via the interface, to manipulate the resource using operations and attributes defined in the Web services definition language file.

2. The method of claim 1, wherein the interface is a stateful Web service interface, and wherein the instance remains persistent in the data processing system.

3. The method of claim 1, wherein the operations includes at least one of logical device operations, device operations, and operations that manipulate attributes of the resource.

4. The method of claim 3, wherein the logical device operations invoke a set of workflow scripts to manipulate the resource physically.

5. The method of claim 3, wherein device operations are operations invoked by a client application to manipulate the resource.

6. The method of claim 3, wherein operations that manipulate attributes of the resource include at least one of get resource properties and set resource properties operations.

7. The method of claim 1, wherein defining operations and attributes of resources in a Web services definition language file includes:
defining common resource properties in the schema section of the Web services definition language file, wherein the common resource properties are shared by resources in the data center;
defining resource properties that are specific to a type of resources in the schema section;
defining a set of data elements in the schema section; and
defining a set of messages subsequent to the schema section, wherein the set of messages include at least one of the set of data elements in the schema section.

8. The method of claim 7, further comprising:
defining a set of operations in a port type, wherein each of the set of operations include at least one of an input, an output, and a combination of an input and an output;
defining a binding for a message format, wherein the binding includes the set of operations defined in the port type; and
defining at least one Web services, wherein the Web services include a name and the binding defined for the message formats.

9. The method of claim 1, wherein the Web services definition file includes at least one Web service representing at least one of the resources in the data center.

10. The method of claim 1, wherein the resources includes at least one of a server, a customer, an application, an application tier, a switch, a router, a data container, a load balancer and software products.

11. The method of claim 1, wherein the operations defined in the Web services definition language file includes at least one of retrieving a resource property of the resource based on a property name, setting a resource property of the resource using the property name, retrieving a list of resource properties of the resource, performing device operations on the resource, and defining relationships between the resource and another resource in the data center.

12. The method of claim 11, wherein device operations include at least one of adding a server resource to an application tier resource, removing the server resource from an application tier resource, and setting the server resource in maintenance mode.

13. The method of claim 12, wherein defining relationships between the resource and another resource in the data center includes at least one of associating the resource with another resource in the data center with a relationship type, disassociating the resource from another resource with the relationship type, and finding all relationship types associated with the resource.

14. The method of claim 1, wherein an endpoint reference of the instance of the resource is stored in a client handler on the data processing system, and wherein the endpoint reference is included in a message header for subsequent invocation of operations on the instance.

15. A data processing system for combining resource properties and device operations of resources in a data center, the data processing system comprising:
defining means for defining operations and attributes of resources in a Web services definition language file;
invoking means for invoking an interface for an instance of a resource in the data center; and
invoking means for invoking an operation on the instance, via the interface, to manipulate the resource using operations and attributes defined in the Web services definition language file.

16. The data processing system of claim 15, wherein invoking means for invoking an operation on the instance, via the interface, to manipulate the resource includes invoking means for invoking at least one of logical device operations, device operations, and operations that manipulate attributes of the resource

17. The data processing system of claim 15, wherein invoking means for invoking an operation on the instance, via the interface, to manipulate the resource includes at least one of retrieving means for retrieving a resource property of the resource based on a property name, setting means for setting a resource property of the resource using the property name, retrieving means for retrieving a list of resource properties of the resource, performing means for performing device operations on the resource, and defining means for defining relationships between the resource and another resource in the data center.

18. The data processing system of claim 17, wherein performing means for performing device operations on the resource includes at least one of adding means for adding a server resource to an application tier resource, removing means for removing the server resource from an application tier resource, and setting means for setting the server resource in maintenance mode.

19. The data processing system of claim 15, wherein defining means for defining operations and attributes of resources in a Web services definition language file includes:
defining means for defining common resource properties in the schema section of the Web services definition language file, wherein the common resource properties are shared by resources in the data center;
defining means for defining resource properties that are specific to a type of resources in the schema section;
defining means for defining a set of data elements in the schema section; and
defining means for defining a set of messages subsequent to the schema section, wherein the set of messages include at least one of the set of data elements in the schema section.

20. The data processing system of claim 17, further comprising:
defining means for defining a set of operations in a port type, wherein each of the set of operations include at least one of an input, an output, and a combination of an input and an output;
defining means for defining a binding for a message format, wherein the binding includes the set of operations defined in the port type; and
defining means for defining at least one Web services, wherein the Web services include a name and the binding defined for the message formats.

21. A computer program product in a computer readable medium for combining resource properties and device operations of resources in a data center, the computer program product comprising:
first instructions for defining operations and attributes of resources in a Web services definition language file;
second instructions for invoking an interface for an instance of a resource in the data center; and
third instructions for invoking an operation on the instance, via the interface, to manipulate the resource using operations and attributes defined in the Web services definition language file.

22. The computer program product of claim 21, wherein first instructions for invoking an operation on the instance, via the interface, to manipulate the resource includes first sub-instructions for invoking at least one of logical device operations, device operations, and operations that manipulate attributes of the resource

23. The computer program product of claim 21, wherein first instructions for invoking an operation on the instance, via the interface, to manipulate the resource includes at least one of first sub-instructions for retrieving a resource property of the resource based on a property name, second sub-instructions for setting a resource property of the resource using the property name, third sub-instructions for retrieving a list of resource properties of the resource, fourth sub-instructions for performing device operations on the resource, and fifth sub-instructions for defining relationships between the resource and another resource in the data center.

24. The computer program product of claim 23, wherein the fourth sub-instructions includes at least one of first instructions for adding a server resource to an application tier resource, second instructions for removing the server resource from an application tier resource, and third instructions for setting the server resource in maintenance mode.

25. The computer program product of claim 21, wherein the first instructions includes:
first sub-instructions for defining common resource properties in the schema section of the Web services definition language file, wherein the common resource properties are shared by resources in the data center;
second sub-instructions for defining resource properties that are specific to a type of resources in the schema section;
third sub-instructions for defining a set of data elements in the schema section; and
fourth sub-instructions for defining a set of messages subsequent to the schema section, wherein the set of messages include at least one of the set of data elements in the schema section.

26. The computer program product of claim 25, further comprising:
fifth sub-instructions for defining a set of operations in a port type, wherein each of the set of operations include at least one of an input, an output, and a combination of an input and an output;
sixth sub-instructions for defining a binding for a message format, wherein the binding includes the set of operations defined in the port type; and
seventh sub-instructions for defining at least one Web services, wherein the Web services include a name and the binding defined for the message formats.

27. A method in a data processing system for providing access to a data center, the method comprising:
receiving a request at a Web service interface to access an instance of resource in the data center; and
responsive to receiving the request, accessing at least one of a resource property and a device operation for the instance of the resource through a stateful Web service associated with the Web service interface in which the stateful Web service allows for access to resource properties and device operations for the instance of the resource in the data center.

28. The method of claim 27, wherein the device operation is a logical device operation.

29. The method of claim 27, wherein the resource properties and the device operations for the instance of the resource are defined in a Web services definition language file.

30. The method of claim 27, wherein the access includes at least one of changing the resource properties and invoking the device operations.

31. A data processing system for providing access to a data center, the data processing system comprising:
receiving means for receiving a request at a Web service interface to access an instance of resource in the data center; and
accessing means, responsive to receiving the request, for accessing at least one of a resource property and a device operation for the instance of the resource through a stateful Web service associated with the Web service interface in which the stateful Web service allows for access to resource properties and device operations for the instance of the resource in the data center.

32. The data processing system of claim 31, wherein the device operation is a logical device operation.

33. The data processing system of claim 31, wherein the resource properties and the device operations for the instance of the resource are defined in a Web services definition language file.

34. The data processing system of claim 31, wherein the access includes at least one of changing the resource properties and invoking the device operations.

35. A computer program product in a computer readable medium for providing access to a data center, the computer program product comprising:
first instructions for receiving a request at a Web service interface to access an instance of resource in the data center; and
second instructions, responsive to receiving the request, for accessing at least one of a resource property and a device operation for the instance of the resource through a stateful Web service associated with the Web service interface in which the stateful Web service allows for access to resource properties and device operations for the instance of the resource in the data center.

36. The computer program product of claim 35, wherein the device operation is a logical device operation.

37. The computer program product of claim 35, wherein the resource properties and the device operations for the instance of the resource are defined in a Web services definition language file.

38. The computer program product of claim 35, wherein the access includes at least one of changing the resource properties and invoking the device operations.
